(19) United States
(12) Patent Application Publication
(10) Pub. No.: US 2024/0048811 A1
(43) Pub. Date: Feb. 8, 2024

(54) Human-computer Interaction Method Based on In-video Advertisements

(71) Applicant: Zyetric Technologies Limited, Hong Kong (HK)

(72) Inventor: Pak Kit Lam, Hong Kong (HK)

(73) Assignee: Zyetric Technologies Limited, Hong Kong (HK)

(21) Appl. No.: 18/223,614

(22) Filed: Jul. 19, 2023

(30) Foreign Application Priority Data
Aug. 2, 2022 (CN) 202210918651.3
Dec. 29, 2022 (CN) 202211711418.4

(51) Int. Cl. H04N 21/478; H04N 21/81; H04N 21/4728; H04N 21/858

(52) U.S. Cl. CPC H04N 21/478; H04N 21/812; H04N 21/4728; H04N 21/8586

(57) ABSTRACT

A human-computer interaction method based on in-video advertisements, including steps of: S1. detecting a user's action of activating an in-video advertisement in the process of playing a main video, wherein the in-video advertisement is in an in-video advertisement layer, and the in-video advertisement layer is a logical layer above the main video, and the in-video advertisement layer is logically transparent to the main video except for pixels occupied by the in-video advertisement; and S2. triggering an advertisement action when the user's action of activating the in-video advertisement is detected. According to the present disclosure, a video viewer is allowed to listen to or watch an in-video advertisement only when the video viewer is really interested in the product endorsed in the in-video advertisement, which effectively avoids troubling the video viewer with advertisements such as pre-roll advertisements, mid-roll advertisements, and banner advertisements, and improves the advertising efficiency for advertisers.

### CROSS REFERENCE TO RELATED APPLICATIONS

This application claims priority of a CN application No. 2022117114184, filed on Dec. 29, 2022, and CN application No. 2022109186513, filed on Aug. 2, 2022. The contents of CN application No. 2022117114184 and CN application No. 2022109186513 are all hereby incorporated by reference.

### TECHNICAL FIELD

The present disclosure relates to video application technology, and more particularly, to a human-computer interaction method based on in-video advertisements.

### BACKGROUND

Some methods can be found in the prior art of placing advertisements in video streams. Currently, most commercial video streaming platforms, such as YouTube, and TikTok, have advertisements shown preceding or in the middle of a video, known as pre-roll advertisements or mid-roll advertisements, respectively, and even advertisements superimposed on top of a video, known as banner advertisements. However, conventional approaches only focus on how to place advertisements in video streams in various ways, without considering the troubles that these advertisements present to a video viewer. For example, pre-roll advertisements, mid-roll advertisements, and banner advertisements (hereinafter collectively referred to as “PMB advertisements”) trouble video viewers quite much and are far from ineffective for advertisers. It's been surveyed that more than 90% of video viewers skip PMB advertisements wherever possible.

It should be noted that the information disclosed in the Background section above is only for an understanding of the background of the present application and thus may include information that does not constitute prior art known to a person of ordinary skill in the art.

### SUMMARY OF THE INVENTION

It is an objective of the present disclosure to overcome the defects described in the Background above by providing a human-computer interaction method based on in-video advertisements.

To achieve the above objective, the present disclosure adopts the following technical solution.

A human-computer interaction method based on in-video advertisements, including steps of:
S1. detecting a user's action of activating an in-video advertisement in the process of playing a main video, wherein the in-video advertisement is in an in-video advertisement layer, the in-video advertisement layer is a logical layer above the main video, and the in-video advertisement layer is logically transparent to the main video except for pixels occupied by the in-video advertisement; and
S2. triggering an advertisement action when the user's action of activating the in-video advertisement is detected.

Furthermore, a video and/or an audio of the main video is paused when the user's action of activating the in-video advertisement is detected.

Furthermore, if the in-video advertisement is associated with a corresponding audio channel in the in-video advertisement layer, the audio channel in the in-video advertisement layer is initially muted by default, and the advertisement action includes unmuting the audio channel in the in-video advertisement layer.

Furthermore, the action of activating includes hovering a cursor over, clicking, or touching the pixels occupied by the in-video advertisement, or any action that can activate the pixels by the user.

Furthermore, the advertisement action includes any one or more of:
playing a video and an audio of the in-video advertisement over the main video simultaneously;
playing an animation of the in-video advertisement over the main video; and
playing the in-video advertisement in a full-screen mode.

Apparently, the advertisement action may also be displayed in any other form.

Furthermore, the in-video advertisement is associated with a URL in advance, and access to the URL is triggered when the specified user's action of activating (e.g., clicking) the in-video advertisement is detected.

Furthermore, coordinates of pixels occupied by the in-video advertisement are associated with the URL.

Furthermore, the method includes a step of:
S3. stopping the advertisement action and resuming the main video when a user's action of stopping the in-video advertisement is detected.

A computer-readable storage medium, storing a computer program, where the computer program, when executed by a processor, implements a human-computer interaction method based on in-video advertisements, the method including steps of:
S1. detecting a user's action of activating an in-video advertisement in the process of playing a main video, wherein the in-video advertisement is in an in-video advertisement layer, the in-video advertisement layer is a logical layer above the main video, and the in-video advertisement layer is logically transparent to the main video except for pixels occupied by the in-video advertisement; and
S2. triggering an advertisement action when the user's action of activating the in-video advertisement is detected.

The present disclosure is advantageous in the following aspects.

(I) The present disclosure deals with the major problems in the video streaming market, effectively avoids troubling video viewers with PMB advertisements, and improves the advertising efficiency for advertisers.

(II) The present disclosure can be applied to a novel online video streaming platform with interactive advertisements. In the present disclosure, all in-video advertisements can be naturally embedded by an AI engine in eye-catching locations in the main video. Preferably, the in-video advertisement layer, as a logical layer formed above the main video, cannot be skipped or closed and is naturally presented in the main video as an in-video advertisement. The in-video advertisements can completely replace the PMB advertisements.

(III) According to the present disclosure, a video viewer can pause a main video and activate an advertisement action autonomously as desired. If the video viewer finishes watching the video of the advertisement, or may not be interested in the advertisement after watching or listening to part of it, he/she can resume the main video at any time by stopping the advertisement action. In other words, the present disclosure allows a video viewer to listen to or watch the advertisement action only if the viewer is really interested in the product endorsed by the in-video advertisement.

(IV) Advantages of the present disclosure
1. A unique video streaming platform is created without annoying pre-roll advertisements, mid-roll advertisements or banner advertisements;
2. A video viewer is allowed to pause the main video as needed to listen to or watch the advertisement action in detail and resume the main video at any time as he/she wants;
3. Interactive function provides a better user experience for the video viewer and the cost-effectiveness of an advertiser;
4. Many innovative modes of revenue-making through advertisements are possible.

(V) Through the present disclosure, it is possible to create a scalable global online video streaming platform intended for borderless sharing.

### BRIEF DESCRIPTION OF THE DRAWINGS

FIG. 1 is a flowchart of a human-computer interaction method based on in-video advertisements according to the present disclosure.

FIG. 2A is a schematic diagram of a video without in-video advertisements according to an embodiment of the present disclosure.

FIG. 2B is a diagram of interaction with an in-video advertisement layer according to an embodiment of the present disclosure.

FIG. 2C is a schematic diagram of a video with in-video advertisements according to an embodiment of the present disclosure.

FIG. 3 is a flowchart of an embodiment of the present disclosure.

### DETAILED DESCRIPTION OF THE INVENTION

Hereinafter, embodiments of the present disclosure will be described in detail. It should be emphasized that the following description is merely exemplary in nature and is not intended to limit the scope of the present disclosure or applications thereof.

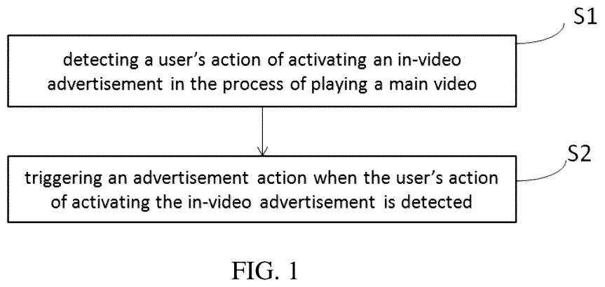

With reference to FIG. 1, an embodiment of the present disclosure provides a human-computer interaction method based on in-video advertisements, including steps of:
S1. detecting a user's action of activating an in-video advertisement in the process of playing a main video,
wherein the in-video advertisement is in an in-video advertisement layer, the in-video advertisement layer is a logical layer above the main video, and the in-video advertisement layer is logically transparent to the main video except for pixels occupied by the in-video advertisement; and
S2. triggering an advertisement action when the user's action of activating the in-video advertisement is detected.

Embodiments of the present disclosure are described further below.

An interactive video streaming platform without any PMB advertisement may be provided by means of the embodiments of the present disclosure, and is referred to as Pause4Ad below.

Using Pause4Ad, all advertisements or video ads (short videos related to the advertisements) can be naturally embedded by an AI engine to eye-catching locations in the main video (i.e., the location nearby where the main character is located). These advertisements in the main video cannot be skipped or closed, and are called in-video advertisements. The most prominent advantage of in-video advertisement is that the disadvantages of PMB advertisements are avoided.

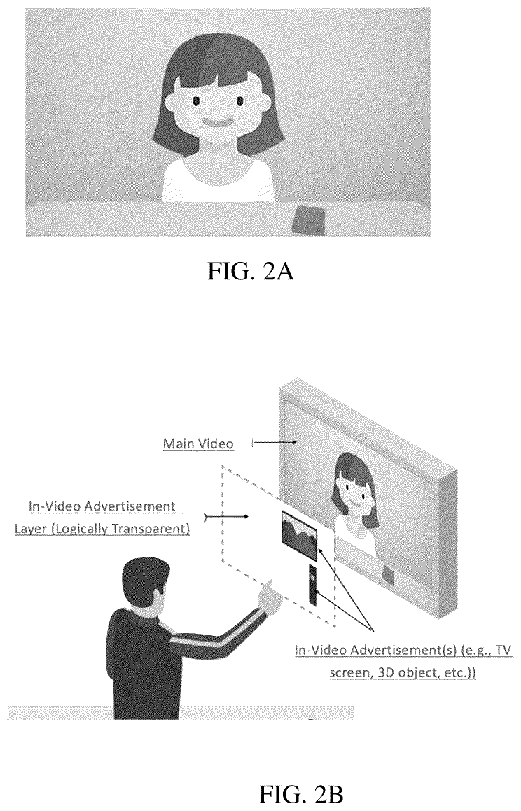

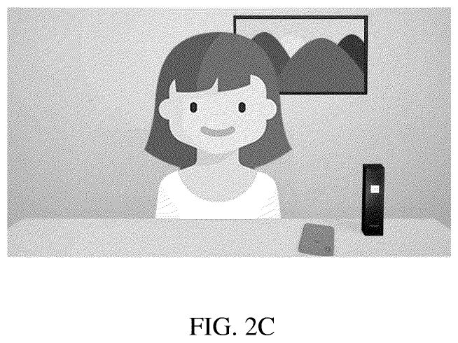

The in-video advertisement of the present disclosure may be one or more advertisements in the form of 2D or 3D images or animations embedded in the main video as shown in FIG. 2A in a natural but eye-catching manner. Preferably, the in-video advertisement cannot be skipped or closed, and the video viewer does not have to watch an undesirable advertisement playback for even a second.

As shown in FIGS. 2B and 2C, the in-video advertisements are naturally presented in the main video and may be embedded:
1. in the background of the main character, such as on a picture frame or TV screen; and
2. as a 3D object, such as a can of cola or an iPhone placed on a table or on the floor in front of the main character.

An example of the in-video advertisement may be a TV screen on a wall and a perfume bottle on a table embedded in the main video by an AI, as shown in the examples of FIGS. 2B and 2C.

By means of Pause4Ad, a video viewer can pause the main video to listen to an audio of the in-video advertisement as needed (muted by default to avoid overlapping with an audio channel of the main video), watch an animation behind a character, and even watch a full-screen advertisement, which are called advertisement action (“AA” in short as shown in the drawings). In other words, examples of the advertisement action include:
1. unmuting the audio of the in-video advertisement (muted by default to avoid overlapping with an audio channel of the main video);
2. a moving animation behind a character that only appears when “Pause4Ad” is on; and
3. a full-screen advertisement that only appears when “Pause4Ad” is on.

The above is merely examples of the advertisement action, and the advertisement may be displayed in any other form.

If the video viewer finishes watching the video of the advertisement, or may not be interested in the advertisement after watching or listening to part of it, she can resume the main video at any time by exiting the in-video advertisement. In other words, the present disclosure allows a video viewer to listen to or watch the advertisement action only if she is really interested in the product endorsed by the in-video advertisement. Moreover, when the video viewer chooses to resume the main video, the main video will be resumed from where she paused, hence the video viewer will not miss even one second of the main video after listening to or watching the advertisement action.

The following are some examples of Pause4Ad, illustrating the main concept of the present disclosure.

### EXAMPLE 1

Pause4Ad is taken to activate the advertisement action of the audio of the in-video advertisement.

In the video of this example, the video viewer hovers a cursor over a TV screen on a wall, which activates a corresponding advertisement action, that is, the main video is paused, and a TV screen audio starts to play (the audio of the in-video advertisement, muted by default to avoid overlapping with the audio of the main video). When the video viewer moves the cursor away from the TV screen, the Pause4Ad function stops, the audio of the in-video advertisement will be muted again, and the main video will resume.

### EXAMPLE 2

Pause4Ad is taken to activate the advertisement action of a 3D object animation.

In the video of this example, the video viewer hovers the mouse over a perfume bottle on a table, which activates an advertisement action, that is, the main video is paused, and an advertisement animation (which may be any type of animation) appears on the background of the picture. When the video viewer moves the mouse away from the perfume bottle on the table, the Pause4Ad function stops, the advertisement animation also stops, and the main video will resume.

### EXAMPLE 3

Pause4Ad is taken to activate the advertisement action of a full-screen mode.

In the video of this example, the video viewer hovers the mouse over the iPhone on the table, which activates a corresponding advertisement action, that is, the main video is paused, and a full-screen advertisement (which may be any full-screen video ad) is played on the screen. When the video viewer clicks on a “Play” button at the bottom of the screen or activates any other method to stop the advertisement action, the Pause4Ad function stops, the full-screen advertisement exits, and the main video will resume.

Furthermore, the video viewer is allowed to pause the main video, and activate the advertisement action, for example, by long pressing or hovering a cursor over the in-video advertisement. The video viewer is allowed to resume the main video and easily stop the advertisement action, for example, by long pressing again or moving the mouse away from the in-video advertisement.

In an embodiment, a specific implementation of the in-video advertisement is described as follows.

The in-video advertisement is placed in as one or more logical layer that contains one or more in-video advertisement associated with corresponding audio channels, which may be called an in-video advertisement layer(s). The in-video advertisement layer is logically transparent except for the pixels occupied by the in-video advertisement. The audio channel is also part of the in-video advertisement layer and may be called an in-video advertisement layer audio channel. The in-video advertisement layer audio channel is initially muted by default to avoid overlapping with the audio channel of the main video, and then unmuted only when the main video is paused (i.e., when the advertisement action is activated).

When the video viewer interacts with the in-video advertisement (e.g., by long pressing on a mobile device or hovering a cursor on a desktop device), the video viewer is actually interacting with the in-video advertisement layer. FIG. 2B shows a schematic diagram of the interaction with the in-video advertisement layer.

In addition, the in-video advertisement occupies only certain portions of the in-video advertisement layer. In other words, the in-video advertisement occupies only some pixels in the entire in-video advertisement layer. The coordinates of these occupied pixels may be predetermined or automatically determined by AI algorithms and then placed into the in-video advertisement layer. Thus, when the video viewer interacts with these occupied pixels, a computer can detect the interaction and can activate some advertisement action. Otherwise, if the video viewer interacts with pixels that are not occupied by the in-video advertisement, nothing will happen, and the main video will continue to play normally.

When the video viewer interacts with the in-video advertisement (i.e., the pixels occupied within the in-video advertisement layer), some advertisement action may be activated, for example, by long-pressing (on a mobile device) or hovering (on a desktop) a cursor over any pixels occupied by the in-video advertisement. For example, the advertisement action that may be activated includes:
1. pausing the main video;
2. playing an audio channel (initially muted) of the in-video advertisement;
3. playing some animation; and/or
4. playing a full-screen advertisement.

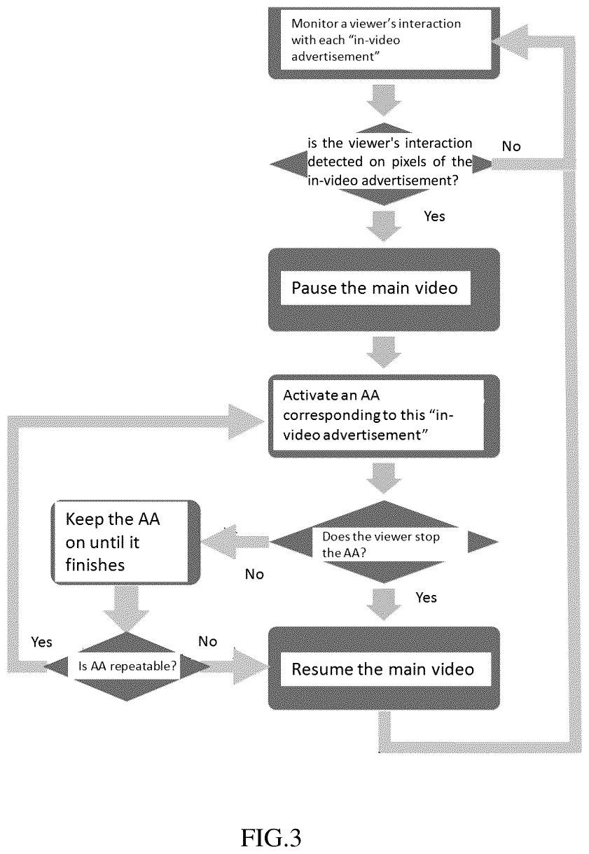

FIG. 3 is a flowchart of an embodiment of the present disclosure.

Advertising resources for one or more in-video advertisements are prepared in advance or may be prepared using some existing graphical editing tool, such as Acrobat Photoshop.

The present disclosure addresses the major problems in the current video streaming market.

(I) For existing subscription-free online video streaming platforms such as YouTube, revenues come primarily from pre-roll advertisements, mid-roll advertisements, or banner advertisements (hereinafter collectively referred to as “PMB advertisements”). PMB advertisements are generally annoying to video viewers and ineffective to advertisers. The present disclosure can effectively avoid troubling the video viewer with PMB advertisements and improve the advertising efficiency for the advertisers.

(II) The present disclosure can be applied to a novel online video streaming platform with interactive advertisements. In the present disclosure, all in-video advertisement layers can be naturally embedded by an AI engine to eye-catching locations in the main video. Preferably, the in-video advertisement layer cannot be skipped or closed and is naturally presented in the main video as an in-video advertisement. The in-video advertisement layer(s) can completely replace the PMB advertisements.

(III) According to the present disclosure, a video viewer can pause the main video and activate the advertisement action autonomously as desired. If the video viewer finishes the advertisement action, or may not be interested in the advertisement after watching or listening to part of it, he/she can resume the main video at any time by stopping the “Pause4Ad” function and exiting the advertisement action. In other words, the present disclosure allows a video viewer to listen to or watch the advertisement action only if the viewer is really interested in the product endorsed by the in-video advertisement.

(IV) Advantages of the present disclosure
1. A unique video streaming platform is created without annoying pre-roll advertisements, mid-roll advertisements or banner advertisements;
2. A video viewer is allowed to pause the main video as needed to listen to or watch the advertisement action and resume the main video at any time as he/she wants;
3. “Pause4Ad”, an interactive function, provides a better user experience for the video viewer and the cost-effectiveness of an advertiser;
4. Many innovative modes of revenue-making through advertisements are possible.

(V) Through the present disclosure, it is possible to create a scalable global online video streaming platform intended for borderless sharing.

A method is also described in Chinese patent application No. 2022109186513 filed by the applicant of the present disclosure, allowing a video viewer to interact with objects in a video by “clicking” on pixels of the interactive objects, which is referred to as “Click2Ad” below.

In a preferred embodiment, Pause4Ad and Click2Ad are combined in the present disclosure to further improve the performance of interaction between the video viewer and the in-video advertisement in a more intuitive manner and to provide advertisers with a more natural and eye-catching approach to advertising in video streaming platforms.

In other words, if a novel video streaming platform employs both Pause4Ad and Click2Ad, the video viewer can “click on an in-video advertisement to access a relevant URL” in addition to being able to pause the main video and activate the advertisement action. The pixels of the in-video advertisement form a URL so that when the video viewer is watching a video and is really interested in an in-video advertisement, she can pause the video at any time to activate the advertisement action, and view more content, such as a product video or a direct link to a product website, through the URL by clicking on the in-video advertisement.

Advertisers may advertise using Pause4Ad and Click2Ad on a video streaming platform. The platform can provide more innovative functionality to significantly improve the experience of video viewers while improving advertising efficiency.

A user may watch the in-video advertisement at any time while watching the main video through a simple operation (e.g., long pressing, hovering a cursor over, and/or clicking on the in-video advertisement), and may return to where the main video is paused to continue watching if she finds the in-video advertisement not interesting.

The in-video advertisement of the present disclosure is a unique approach to placing an advertisement in a video naturally. As a unique approach, Pause4Ad allows video viewers to interact with in-video advertisements only when they are really interested in the product. The present disclosure may be applicable to video streaming platforms, livestreaming, TV programs, and movies.

Those skilled in the art will appreciate that embodiments of the present disclosure may be provided as a method, system, or computer program product. Accordingly, the present disclosure may take the form of an entirely hardware embodiment, an entirely software embodiment or an embodiment combining software and hardware aspects. Furthermore, the present disclosure may take the form of a computer program product embodied on one or more computer-usable storage media, including but not limited to, magnetic disk storage, CD-ROM, optical storage, etc., having computer-usable program code therein.

The present disclosure is described with reference to flowcharts and/or block diagrams of a method, apparatus (systems), and computer program product according to embodiments of the present disclosure. It will be understood that each flow and/or block of the flowcharts and/or block diagrams, and combinations of flows and/or blocks of the flowcharts and/or block diagrams, can be implemented by computer program instructions. Such computer program instructions may be provided to a processor of a general-purpose computer, special-purpose computer, embedded processor, or other programmable data processing apparatus to produce a machine, such that the instructions, which are executed via the processor of the computer or other programmable data processing apparatus, create means for implementing the functions specified in the flow or flows of the flowcharts and/or block or blocks of the block diagrams.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow or flows of the flowcharts and/or block or blocks of the block diagrams.

These computer program instructions may also be loaded onto a computer or other programmable data processing apparatus to cause a series of operational steps to be performed on the computer or other programmable apparatus to produce a computer-implemented process such that the instructions, which are executed on the computer or other programmable apparatus, provide steps for implementing the functions specified in the flow or flows of the flowcharts and/or block or blocks of the block diagrams.

The Background section of the present disclosure may contain background information about the problems to deal with or circumstances of the present disclosure, not necessarily describing the prior art. Therefore, what is contained in the Background section is not an admission by the applicant of the prior art.

The foregoing is a further detailed description of the present disclosure, taken in conjunction with specific/preferred embodiments thereof, and is not to be construed as limiting the present disclosure to the specific embodiments described. It will be appreciated by persons skilled in the art that numerous alternatives and modifications may be made to the described embodiments without departing from the inventive concepts herein, and that such alternatives and modifications are considered to be within the scope of the present disclosure. In the description of this specification, terms of references like “an embodiment”, “some embodiments”, “preferred embodiments”, “examples”, “specific examples”, or “some examples” mean that a particular feature, structure, material, or characteristic described in connection with the embodiment or example is included in at least one embodiment or example of the present disclosure. In this specification, schematic representations of the above terms are not necessarily directed to the same embodiment or example. Furthermore, the particular features, structures, materials, or characteristics described may be combined in any suitable manner in any one or more embodiments or examples. The different embodiments or examples and the features of the different embodiments or examples described in this description can be combined by a person skilled in the art without conflicts. Although embodiments of the present disclosure and their advantages have been described in detail, it should be understood that various changes, substitutions and alterations can be made herein without departing from the scope of the appended claims.

1. A human-computer interaction method based on in-video advertisements, comprising steps of:
S1: detecting a user's action of activating an in-video advertisement in the process of playing a main video,
wherein the in-video advertisement is in an in-video advertisement layer, and the in-video advertisement layer is a logical layer above the main video, and the in-video advertisement layer is logically transparent to the main video except for pixels occupied by the in-video advertisement; and
S2: triggering an advertisement action when the user's action of activating the in-video advertisement is detected.

2. The human-computer interaction method based on in-video advertisements according to claim 1, wherein a video and/or an audio of the main video is paused when the user's action of activating the in-video advertisement is detected.

3. The human-computer interaction method based on in-video advertisements according to claim 1, wherein the action of activating is hovering a cursor over, clicking, touching or interacting with the pixels occupied by the in-video advertisement by the user.

4. The human-computer interaction method based on in-video advertisements according to claim 2, wherein the in-video advertisement is associated with a corresponding audio channel in the in-video advertisement layer, the audio channel in the in-video advertisement layer is initially muted by default, and the advertisement action comprises the audio channel in the in-video advertisement layer being unmuted.

5. The human-computer interaction method based on in-video advertisements according to claim 1, wherein the advertisement action comprises any one or more of:
playing a video and an audio of the in-video advertisement over the main video simultaneously;
playing an animation of the in-video advertisement over the main video; and
playing the in-video advertisement in a full-screen mode.

6. The human-computer interaction method based on in-video advertisements according to claim 1, wherein the in-video advertisement is associated with a URL in advance, and access to the URL is triggered when the user's action of activating the in-video advertisement is detected.

7. The human-computer interaction method based on in-video advertisements according to claim 6, wherein coordinates of pixels occupied by the in-video advertisement are associated with the URL.

8. The human-computer interaction method based on in-video advertisements according to claim 1, further comprising a step of:
S3: stopping the advertisement action when a user's action of stopping the in-video advertisement is detected.

9. The human-computer interaction method based on in-video advertisements according to claim 2, further comprising a step of:
S3: stopping the advertisement action and resuming the main video when a user's action of stopping the in-video advertisement is detected.

10. A computer-readable storage medium, storing a computer program, characterized in that the computer program, when executed by a processor, implements a human-computer interaction method based on in-video advertisements, the method comprising steps of:
S1: detecting a user's action of activating an in-video advertisement in the process of playing a main video, wherein the in-video advertisement is in an in-video advertisement layer, and the in-video advertisement layer is a logical layer above the main video, and the in-video advertisement layer is logically transparent to the main video except for pixels occupied by the in-video advertisement; and
S2: triggering an advertisement action when the user's action of activating the in-video advertisement is detected.
